(19) United States
(12) Patent Application Publication
(10) Pub. No.: US 2016/0221102 A1
(43) Pub. Date: Aug. 4, 2016

(54) Method and Device for Operating a Welding System

(71) Applicant: ROBERT BOSCH GMBH, Stuttgart (DE)

(72) Inventor: Sebastian Zeller, Aspach (DE)

(21) Appl. No.: 15/021,504

(22) PCT Filed: Jul. 8, 2014
(86) PCT No.: PCT/EP2014/064505

§ 371 Date: Mar. 11, 2016

(30) Foreign Application Priority Data
Sep. 13, 2013 (DE) 10 2013 218 360.7

(51) Int. Cl. B23K 9/095; B23K 11/11; B23K 31/00; B23K 11/36

(52) U.S. Cl. CPC B23K 9/0953; B23K 11/36; B23K 11/11; B23K 31/00

(57) ABSTRACT

A method of operating a welding system includes obtaining at least one data element from a data unit. The at least one data element is specific to a respective element of the welding system and the data unit being attached to the respective element. The method further includes reading at least one data element using a portable reading unit. The method further includes transmitting the at least one data element that is obtained to a controller of the welding system. The at least one data element is taken into consideration during the operation of the welding system.

The present invention relates to a method and a device for operating a welding system, in particular for putting a controller of a welding system into operation, preferably for putting a controller of a welding system into operation for the first time, and/or a modification, preferably an extension or implementation, of elements in a controller of a welding system.

In the case of conventional methods and associated devices or device elements for operating a welding system, putting the controller of the welding system into operation or modifying the controller of the welding system particularly takes a relatively long time, because a large number of individual components or elements of which the welding system consists or is formed results in a plethora of possibilities for combining the individual elements with one another. The individual components or elements are to be understood in this case as including, though not exhaustively, the tongs, the transformer, the electrode, the power classes of the welding controller, the welding case, the inverter, the tongs memory or the motors for closing the tongs.

It is also not always the case with customers or the actual users of the welding system that the personnel (which may even be just a single person) planning a plant is also responsible for operating it, putting it into operation and/or carrying out modifications. It is therefore necessary in the prior art that both the (member of) personnel planning the plant and the (member of) personnel responsible for operating it, putting it into operation and/or carrying out modifications are familiar with the welding system, its controller and the elements very exactly and fully, which requires good training of all employees or personnel.

In spite of good training, it is still possible however in the prior art that (a member of) personnel specifies, selects or identifies incorrect elements when operating a welding system, and in particular when putting it into operation (for the first time) and/or modifying it, and inputs or stores these incorrect elements in the controller, and accordingly an incorrect configuration of a welding system can take place.

The present invention is therefore based on the object of overcoming the disadvantages of the prior art and ensuring quick and preferably error-free operation of a welding system. It is intended in particular to ensure that a welding system is put into operation (for the first time) and/or modified quickly and preferably in a manner free from errors. It is also intended to make it feasible for a welding system to be operated, and in particular put into operation (for the first time) and/or modified in a simplified manner, so that preferably even “untrained” personnel are capable of carrying out said activities of operating it, putting it into operation and/or modifying it.

In order therefore to provide a method for operating a welding system, the present invention includes making use of the idea that a portable reading unit reads at least one data element, which is specific to the respective element of the welding system, from a data unit attached to the respective element and the at least one data element that is obtained or read or obtained by the reading is transmitted to a controller of the welding system, the at least one data element being taken into consideration during the operation of the welding system.

As a result, it is possible particularly quickly and easily when setting up and/or putting into operation and/or modifying the controller of the welding system to integrate in a controller, implement, modify or configure in a controller an element, but in particular a multiplicity of elements, with the aid of the data unit(s) attached thereto, or to configure the controller or take these elements into consideration.

A further advantage of the present invention is that (a member of) personnel, a user or a specialist worker no longer has to be trained specifically and extensively and that errors due to incorrect inputs are prevented, since the portable reading unit preferably just has to be brought into the vicinity of the welding system, so that preferably a near field communication (NFC) is used for the reading unit to record and read the data units of the respective elements, and preferably all of the data units of the respective elements, of the welding system, which are subsequently transmitted to the controller, whereby it is made possible quickly and easily to record all of the elements of the welding system and subsequently operate the welding system correspondingly.

A data unit is in this case preferably a unit from which data, data elements or information can be read, or from which they can be recorded, which preferably takes place optically, by way of (alternating) fields or electromagnetic (alternating) fields. The data unit is consequently preferably a unit or a (data) means on/in which data, data elements or information are stored, contained or deposited.

The portable reading unit is preferably designed and configured in such a way that it can read the at least one data unit contactlessly. For example, it may be equipment or a portable reading unit that has a scanner or optical reading units. More preferably, the equipment or the portable reading unit could enter into an information connection with the data unit, an information connection being understood here as meaning that information can be exchanged wirelessly in any way known to a person skilled in the art. The contactless reading takes place particularly preferably by way of or through near field communication, that is to say by way of or through NFC (Near Field Communication). For example, a corresponding cell phone, notebook or smart phone could be involved here, or else a tablet.

Consequently, in the case of a preferred method, all that has to take place is a reading of all the data units that are attached to the respective elements of the welding plant or the welding system, the data elements or items of information that are read being transmitted from the data units to the controller of the welding system or the welding plant automatically or by way of activation or request by (a member of) personnel. The controller of the welding system can subsequently be configured while taking into consideration these and preferably all the data elements.

In this case, “portable” preferably means that the reading unit is intended in particular to be used in a mobile manner, i.e. that the reading unit is also intended and set up by the operator not to be installed statically, for example at a fixed workplace, but by contrast can for example be carried.

The controller is preferably set up and designed for operating the welding system, putting it into operation and/or modifying it.

In the case of a further preferred method, the method makes possible, comprises or describes putting a controller of a welding system into operation, and preferably putting it into operation for the first time, and/or modifying elements in a controller of a welding system, the at least one data element being taken into consideration when putting the welding system or the controller into operation, putting it into operation for the first time and/or modifying it.

The method is consequently additionally or also suitable for providing a method for putting a controller of a welding system into operation and/or modifying elements in a controller of a welding system, a portable reading unit preferably reading at least one data element, which is specific to the respective element of the welding system, from a data unit attached to the respective element, and the at least one data element obtained being transmitted to the controller of the welding system and (more) preferably the at least one data element being taken into consideration during the activities of putting into operation, putting into operation for the first time and/or modification, and particularly preferably being taken into consideration by the controller or associated (computing) units or an associated (computing) unit. The activity of putting into operation is preferably one of putting into operation for the first time.

The modification of elements in the controller may preferably be the result here of a modification of the elements of the welding system, in that for example further elements are added to the welding system and/or existing elements are replaced by other elements. Consequently, the modification preferably also describes an implementation of further elements in the welding system and/or a modification and/or extension of the configuration or the setup of the welding system. The welding system particularly preferably comprises a plant for welding or a welding plant. It may, however, also preferably be a modification and/or parameter modification of the data already present in the controller; or a modification and/or parameter modification of existing data, data elements and/or information may preferably be performed.

The “specific” data element is preferably understood as meaning that the data element can be assigned or is assigned uniquely to a specific element, and a unique assignment of a data element, and consequently preferably also of a data unit, is preferably given or made possible by the reading unit or by way of further additional systems, arrangements or corresponding software that are stored on (a) database(s) or the like, or which can be accessed by the reading unit and/or the controller of the welding unit. The additional systems, arrangements or the corresponding software, and also the database(s), may in this case be present or arranged locally or non-locally. Furthermore, the connection to these may be established in a wire-bound or wireless manner.

In the case of a further preferred method, the data unit comprises, is or has a passive data unit. “Passive” means in this context that the activation element as such is not capable of sending out data elements on its own without outside influence, and it preferably means that the data unit does not have any power source of its own, but is supplied (with power) or induced to send out data elements by external effects, in particular by an electromagnetic alternating field. Consequently, in the case where a passive data unit is used, the necessary energy is generated by the reading unit.

However, it could for example also be possible that the data unit is not a passive data unit, but is provided with a power supply of its own. For example, the data unit may in this case be designed as an (active) RFID transponder/chip, whereby a greater range of the data transmission is made possible by contrast with a passive transponder or passive data unit.

In the case of a further preferred method, the data unit is selected from a group at least consisting of a QR code, barcode, optical marker, microchip, NFC chip and/or RFID chip. A data unit from the aforementioned group is preferably attached, adhesively fixed or the like to each element of the welding system or the welding plant. All a user or the (member of) personnel has to do is to use the portable reading unit either to record, read or scan in all the codes or markers, or if microchips, NFC chips and/or RFID chips are concerned, record or read all of these chips, consequently preferably to approach the chips close enough for the chips to be within an active range of the alternating field sent out by the reading unit. If only one data unit is concerned, correspondingly only this one data unit has to be read, scanned in or recorded.

In the case of a further preferred method, the at least one data element or a multiplicity of the at least one data elements is/are stored in the controller. Consequently, the controller preferably has a memory unit in which the data elements, a multiplicity of individual respective data elements or the at least one data element can be stored or deposited. Therefore, the at least one data element is for example read or recorded by the reading unit and subsequently transmitted to the controller. This transmission may in this case take place in a wireless or wire-bound manner. For example, a transmission could take place by way of WLAN, Bluetooth or infrared. A cable that is directly or indirectly connected to the controller could also be connected to the reading unit.

The wireless transmission may preferably also take place directly or indirectly to the controller. Indirectly may mean in this case that the data are transmitted to the controller of the welding system initially by way of a server, a computer, a further controller or the like. After the transmission, the data elements or the at least one data element is/are consequently stored in the controller or an associated memory or an associated memory unit. This memory unit does not have to belong physically to the controller; it could for example be a decentralized memory unit which the controller can access, for example by way of a network. For example, data elements may already be stored in the controller or the associated memory unit, and the at least one data element that is read or recorded is added to these data elements or added in addition to these data elements. This is the case in particular when implementing or extending the welding system. A number of data elements could also be added in addition to the already present, stored data elements.

In the case of a further preferred method, the reading unit reads a multiplicity of data units which are attached to a multiplicity of elements, and at least one data unit, preferably precisely one data unit, being attached to each element.

Accordingly, each element of the welding system or the welding plant preferably has precisely one data unit, a data unit attached thereto, and preferably all of the data units are read or the associated data elements are recorded, and preferably transferred or transmitted to the controller.

In the case of a further preferred method, the controller of the welding system is configured or set up or the controller is put into operation by the at least one data element (read) from the data unit. Since the controller of the welding system must be adapted to the type and design, and also the individual elements that are present, and must function accordingly, the controllers are configured on the basis of the elements belonging to the welding system. By the present invention or embodiment, this configuration does not take place manually by inputs of the (member of) personnel, but on the basis of the data elements or the at least one data element read and transmitted by the reading unit (and/or possible further interposed units, IT units, servers, or the like).

Accordingly, the at least one data element or the data elements is/are preferably taken into consideration in such a manner that a configuration of the controller is performed, carried out or realized on the basis of this data element or the data elements.

In the case of a further preferred method, all of the elements of the welding system have a data unit and all of the data elements from the data units are taken into consideration and recorded by the controller, a configuration of the welding system being set up on the basis of all the data elements.

In the case of a further preferred method, the at least one data element comprises, includes or describes at least one item of information concerning the associated element and/or at least one item of information concerning the associated element is determined by the at least one data element by way of further sources. Therefore, although the configuration is preferably performed on the basis or on account of the at least one data element, it is not performed directly by the data element itself, but instead at least one item of information or a further item of information is initially determined from the data element and the configuration is subsequently performed from this at least one item of information or further information. Consequently, the configuration is only performed on an indirect basis, in an indirect way, by way of the at least one data element or the data elements.

Therefore, the data element preferably relies for example on a database, a memory unit, in which there is/are stored in addition to the at least one data element further associated data or information, which describe and/or define the element of the data element more precisely, and the configuration of the controller is made possible or carried out by this information or data. The database or the information may in this case be stored in the reading unit or else in the controller or associated memory unit and/or database or else be retrieved by way of a network or the like. For example, the data element could be a combination of numbers, a combination of numbers and letters, a pattern, an (activation) code around a series of numbers and/or letters and/or a barcode or any other data element or any other code, and in this case a logic operation or item of information may be be stored for example in a database for this combination of numbers for example, showing that the combination of numbers stands for an electrode. Furthermore, other items of information, such as certain values, specific details and so on, concerning the electrode may for example be assigned to the data element in this way. Accordingly, the data element may transmit, have, include or contain for the respective element items of information or data directly or indirectly for the configuration of the controller.

Consequently, not (only) the data elements or the at least one data element is/are used for the configuration, but preferably associated further items of information. Furthermore, data element may preferably be transferred by the portable reading unit in a changed or unchanged form. This should be understood as meaning that the reading unit already accesses the further items of information, these items are stored in the reading unit and the reading unit does not transmit to the controller the data elements themselves, but already the respective associated information.

The present invention is also directed to a device for operating a welding system with a portable reading unit, by which at least one data element, which is specific to the respective element of the welding system, can be read from a data unit attached to the respective element. Furthermore, the reading unit has a receiving/transmitting unit, whereby the at least one data element obtained can be transmitted to a controller of the welding system, it being possible for the at least one data element to be taken into consideration during the operation of the welding system.

The device is however preferably also directed to the activity of putting into operation (for the first time) a controller of a welding system and/or the modification of elements in a controller of a welding system, it being possible for the at least one data element to be taken into consideration for the putting into operation (for the first time) and/or modification.

In the case of a preferred embodiment, the controller has a further receiving/transmitting unit, to which the data element can be transmitted. Furthermore, the controller preferably has a computing unit, by which the data element can be obtained and can be processed.

Further advantages and embodiments are evident from the appended drawing, in which:

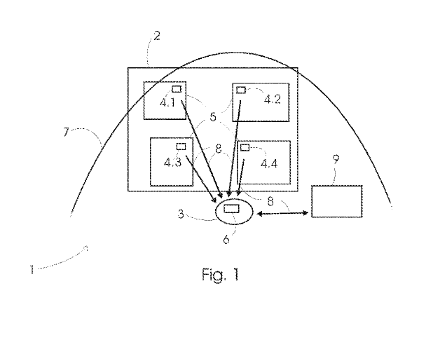

FIG. 1 shows a schematic representation of the device for operating a welding system.

With the reference numeral 1, the device for operating a welding system (or putting it into operation (for the first time) and/or modifying it) is identified. It can be seen here that a reading unit 3 has or comprises a receiving/transmitting unit 6 and that a welding system 2 has or comprises here by way of example four elements 5, each of these elements 5 comprising a data unit 4.1-4.4 attached thereto. Deposited or stored in these data units 4.1-4.4 are the data elements specific to each element, which can be read by the reading unit 3 and/or its receiving/transmitting unit 6, which is represented by the arrows 8, which represent an information/data flow or information/data (element) exchange. Similarly, there is such an arrow 8 between the reading unit 3 and the controller 9 of the welding system 2. Here, the controller 9 is arranged outside the welding system 2, this merely having been chosen with a view to the representation, and so the controller could similarly be arranged inside the welding system 2.

The reference numeral 7 identifies an (alternating) field, which is generated by the reading unit 3 or the receiving/transmitting unit 6 and defines a region around the reading unit 3 or the receiving/transmitting unit 6 that is penetrated by the field in order to supply the data units 4.1-4.4 with energy, and to make it possible for the data elements to be able to be read from these units. It would however also be possible here that only a smaller region around the reading unit 3 that only partially reaches the data units 5 is penetrated by the (alternating) field, so that a recording of all the data elements or a penetration of all the data units by the (alternating) field is made possible by a movement or a change of the position of the reading unit 3 or of the receiving/transmitting unit 6.

In FIG. 1, however, all of the data elements can be recorded by the reading unit 3 or the receiving/transmitting unit 6, or can be recorded from the data units 4.1-4.4 and can be transmitted to the controller 9, so that easy reading of all the data units 4.1-4.4 is possible.

After a transmission of all the data elements to the controller 9, for example by way of a further receiving/transmitting unit that is possibly present in the controller but is not shown to a computing unit or memory unit of the controller that is not shown, a multiplicity of the data elements can be taken into consideration by the controller during the operation of the welding system, or these elements are taken into consideration.

The applicant reserves the right to claim all of the features disclosed in the application documents as essential to the invention, as long as they are novel over the prior art individually or in combination.

### List of Reference Numerals

1 device
2 welding system
3 reading unit
4.1 data unit
4.2 data unit
4.3 data unit
4.4 data unit
6 receiving/transmitting unit
7 (alternating) field
8 arrows
9 controller

1. A method for operating a welding system, comprising:
obtaining at least one data element from a data unit, the at least one data element being specific to a respective element of the welding system and the data unit being attached to the respective element;
reading at least one data element using a portable reading unit; and
transmitting the at least one data element to a controller of the welding system; and
taking into consideration the at least one data element during the operation of the welding system.

2. The method for operating a welding system as claimed in claim 1, further comprising:
at least one of putting the controller of the welding system into operation and carrying out a modification of elements in the controller of the welding system; and
taking into consideration the at least one data element during the activities of at least one of (i) putting the welding system into operation, (ii) putting the welding system into operation for the first time and (iii) modifying elements in the controller.

3. The method for operating a welding system as claimed in claim 1, wherein
the data unit includes a passive data unit.

4. The method for operating a welding system as claimed in claim 1, wherein
the data unit is selected from a group consisting of at least one of a QR code, barcode, optical marker, microchip, NFC chip and RFID chip.

5. The method for operating a welding system as claimed in claim 1, further comprising:
storing the at least one data element or a multiplicity of the at least one data elements in the controller.

6. The method for operating a welding system as claimed in claim 1, further comprising
reading a multiplicity of data units, the data units being attached to a multiplicity of elements; and
attaching the at least one data unit to each element.

7. The method for operating a welding system as claimed in claim 1, further comprising:
configuring the controller of the welding system by the at least one data element from the data units.

8. The method for operating a welding system as claimed in claim 1, further comprising:
taking into consideration all of the data elements from the data units;
recording all of the data elements by the controller; and
setting up the configuration of the welding system on the basis of all the data elements, wherein all of the elements of the welding system have a data unit.

9. The method for operating a welding system as claimed in claim 1, further comprising:
determining at least one item of information concerning an associated element by the at least one data element using further sources, at least one of the at least one data element including or describing at least one item of information concerning the associated element.

10. A device for operating a welding system, comprising:
a controller;
a data unit attached to a respective element of the welding system;
a portable reading unit configured to read at least one data element, the at least one data element being specific to the respective element, the reading unit having:
a receiving/transmitting unit configured to transmit the at least one data element to the controller of the welding system, the at least one data element being taken into consideration during the operation of the welding system.
